(19) United States
(12) Patent Application Publication
(10) Pub. No.: US 2022/0178794 A1
(43) Pub. Date: Jun. 9, 2022

(54) Disposable Micro Tissue Grinder

(71) Applicant: Hemp Synergistics, Leetsdale, PA (US)

(72) Inventors: Ronald T. Fazio, Beaver Falls, PA (US); Daniel P. Kohler, McKees Rocks, PA (US)

(21) Appl. No.: 17/544,395

(22) Filed: Dec. 7, 2021

Related U.S. Application Data
(60) Provisional application No. 63/122,637, filed on Dec. 8, 2020.

(51) Int. Cl. G01N 1/28

(52) U.S. Cl. CPC G01N 1/286; G01N 2001/2866

(57) ABSTRACT

A tissue grinding system includes a hollow collection tube defining an internal cavity including an opening and a lid corresponding to the opening, a pestle including a rod and a head extending from an end of the rod having a shape corresponding to the shape of the internal cavity, and at least one groove extending about an outer surface of the head of the pestle at an angle. The at least one groove extends a depth into the head of the pestle. The head of the pestle is configured to grind a substance within the internal cavity.

### CROSS-REFERENCE TO RELATED APPLICATIONS

This application claims priority to U.S. Provisional Patent Application Ser. No. 63/122,637, titled “Disposable Micro Tissue Grinder” and filed on Dec. 8, 2020, the disclosure of which is incorporated herein by reference in its entirety.

### BACKGROUND OF THE INVENTION

This present disclosure relates to a device that is designed to facilitate the grinding and homogenization of difficult tissue matrices.

Biological matrices, such as plant tissue, are highly varied and often comprised of tough, difficult to grind materials. Laboratory and field testing of biological matrices is common and is used for environmental, biological, agricultural, and forensic purposes. These tests require a highly homogenized and consistent sample prior to testing.

Specialized tissue grinders for plant materials exist, but they are larger, automated, non-disposable devices that cannot be easily used in the field or can process small amounts of material (less than 1 gram).

Disposable tissue grinders are valuable in that they avoid the need for cleaning and sterilization prior to use or in between samples. Disposable tissue grinders are commercially available, but they lack the capacity to process plant materials.

### SUMMARY OF THE INVENTION

A disposable tissue grinder that is specifically designed for tough, non-homogenous materials, such as plant material.

The tissue grinder possesses an overall shape and design to be used with a disposable microtube. The tissue grinder has cut grooves that facilitate cutting and grinding, as well as the prevention of the formation of packed material in the base of the microtube.

The tissue grinder may be of several shapes and designs. The tissue grinder possesses at least one cut groove up to dozens of cut grooves. The shape, angle of attack, and depth of the groove may be varied to meet particular applications or construction limitations.

A tissue grinding device may include: a pestle having a rod and a head extending from an end of the rod, the head having a shape corresponding to a shape of an internal cavity of a hollow collection tube; and at least one groove extending about an outer surface of the head of the pestle at an angle, the at least one groove extending a depth into the head of the pestle. The head of the pestle may be configured to grind a substance within the internal cavity of the hollow collection tube. The at least one groove may include 2-5 grooves. The at least one groove may include at least 12 grooves. The at least one groove may include at least one major groove and at least one minor groove. The at least one major groove may include two major grooves, and the at least one minor groove may include a plurality of minor grooves. The plurality of minor grooves may include 10 minor grooves. The depth may be 0.5-5 millimeters. The depth may be 0.9-1.1 millimeters. The at least one groove may include a width, and the width may be 0.5-2.0 millimeters. The width may be 0.9-1.1 millimeters. The angle may be 0-60 degrees. The angle may be 15-25 degrees. The at least one groove may be a triangle. The at least one groove may be a quadrilateral.

A tissue grinding system may include: a hollow collection tube defining an internal cavity and including an opening and a lid corresponding to the opening; and a tissue grinding device including: a pestle having a rod and a head extending from an end of the rod, the head having a shape corresponding to the shape of the internal cavity; and at least one groove extending about an outer surface of the head of the pestle at an angle, the at least one groove extending a depth into the head of the pestle. The head of the pestle may be configured to grind a substance within the internal cavity. The hollow collection tube may include a disposable material. The at least one groove may include at least one major groove and at least one minor groove. The at least one groove may be a triangle. The at least one groove may be a quadrilateral having a width. The at least one groove may be a square.

Examples of the present invention will now be described in the following numbered clauses:

Clause 1. A tissue grinding device comprising: a pestle comprising a rod and a head extending from an end of the rod, the head having a shape corresponding to a shape of an internal cavity of a hollow collection microtube; and at least one groove extending about an outer surface of the head of the pestle at an angle, the at least one groove extending a depth into the head of the pestle, wherein the head of the pestle is configured to grind a substance within the internal cavity of the hollow tube.

Clause 2. The tissue grinding device of clause 1, wherein the at least one groove comprises 2-5 grooves.

Clause 3. The tissue grinding device of clause 1 or 2, wherein the at least one groove comprises at least 12 grooves.

Clause 4. The tissue grinding device of any of clauses 1-3, wherein the at least one groove comprises at least one major groove and at least one minor groove.

Clause 5. The tissue grinding device of any of clauses 1-4, wherein the at least one major groove comprises two major grooves, and the at least one minor groove comprises a plurality of minor grooves.

Clause 6. The tissue grinding device of any of clauses 1-5, wherein the plurality of minor grooves comprises 10 minor grooves.

Clause 7. The tissue grinding device of any of clauses 1-6 wherein the depth is 0.5-5 millimeters.

Clause 8. The tissue grinding device of any of clauses 1-7, wherein the depth is 0.9-1.1 millimeters.

Clause 9. The tissue grinding device of any of clauses 1-8, wherein the at least one groove comprises a width, and wherein the width is 0.5-2.0 millimeters.

Clause 10. The tissue grinding device of any of clauses 1-9, wherein the width is 0.9-1.1 millimeters.

Clause 11. The tissue grinding device of any of clauses 1-10, wherein the angle is 0-60 degrees.

Clause 12. The tissue grinding device of any of clauses 1-11, wherein the angle is 15-25 degrees.

Clause 13. The tissue grinding device of any of clauses 1-12, wherein the at least one groove is a triangle.

Clause 14. The tissue grinding device of any of clauses 1-13, wherein the at least one groove is a quadrilateral.

Clause 15. A tissue grinding system comprising: a hollow collection tube defining an internal cavity; and a tissue grinding device comprising: a pestle comprising a rod and a head extending from an end of the rod, the head having a shape corresponding to the shape of the internal cavity; and at least one groove extending about an outer surface of the head of the pestle at an angle, the at least one groove extending a depth into the head of the pestle, wherein the head of the pestle is configured to grind a substance within the internal cavity.

Clause 16. The tissue grinding system of clause 15, wherein the hollow collection tube comprises a disposable material.

Clause 17. The tissue grinding system of clause 15 or 16, wherein the at least one groove comprises at least one major groove and at least one minor groove.

Clause 18. The tissue grinding system of any of clauses 15-17, wherein the at least one groove is a triangle.

Clause 19. The tissue grinding system of any of clauses 15-18, wherein the at least one groove is a quadrilateral having a width.

Clause 20. The tissue grinding system of any of clauses 15-19, wherein the at least one groove is a square.

### BRIEF DESCRIPTION OF THE DRAWINGS

FIG. 1 shows a perspective view of a tissue grinder according to one embodiment or embodiment of the present disclosure;

FIG. 2 shows a perspective view of a collection tube of the tissue grinder of FIG. 1;

FIG. 3 shows side view of the grinder tool of the tissue grinder of FIG. 1;

FIG. 4 shows a side view of the head of the grinder tool of FIG. 3;

FIG. 5 shows a cross-sectional view of the head of the grinder tool of FIG. 3 at line A-A;

FIG. 6 shows a cross-sectional view of a head of a grinder tool according to another embodiment or aspect of the present disclosure;

FIG. 7 shows a cross-sectional view of a head of a grinder tool according to another embodiment or aspect of the present disclosure;

FIG. 8 shows a cross-sectional view of a head of a grinder tool according to another embodiment or aspect of the present disclosure;

FIG. 9 shows a cross-sectional view of a head of a grinder tool according to another embodiment or aspect of the present disclosure;

FIG. 10 shows a cross-sectional view of a head of a grinder tool according to another embodiment or aspect of the present disclosure;

FIG. 11 shows a cross-sectional view of a head of a grinder tool according to another embodiment or aspect of the present disclosure;

FIG. 12 shows a cross-sectional view of a head of a grinder tool according to another embodiment or aspect of the present disclosure;

FIG. 13 shows a cross-sectional view of a head of a grinder tool according to another embodiment or aspect of the present disclosure;

FIG. 14 shows a cross-sectional view of a head of a grinder tool according to another embodiment or aspect of the present disclosure;

FIG. 15 shows a cross-sectional view of a head of a grinder tool according to another embodiment or aspect of the present disclosure;

FIG. 16 shows a cross-sectional view of a head of a grinder tool according to another embodiment or aspect of the present disclosure;

FIG. 17 shows a cross-sectional view of a head of a grinder tool according to another embodiment or aspect of the present disclosure.

### DESCRIPTION OF THE INVENTION

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. As used in the specification and the claims, the singular form of “a”, “an”, and “the” include plural referents unless the context clearly dictates otherwise.

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

A non-limiting embodiment of the present invention relates to the design of a disposable tissue grinder that is specifically designed for tough, non-homogenous materials, such as plant material, possesses an overall shape and design to be used with a disposable microtube, has cut grooves that facilitate cutting and grinding, and may possesses at least one cut groove up to dozens of cut grooves. The shape, angle of attack, and depth of the groove(s) may be varied to meet particular applications or construction limitations.

Tissue grinders according to the present disclosure may include four main features, which can be variable depending on how the tissue grinder 10 will be used: A) the angle of groove(s) in relationship to the long axis of the grinder, B) the depth of the grooves, C) the width of the grooves and D) the number of grooves

The following example is presented to demonstrate the general principles of the invention of this disclosure. The invention should not be considered as limited to the specific examples presented. All parts and percentages in the examples are percent weight, based on the total weight of the pharmaceutical composition, unless otherwise indicated.

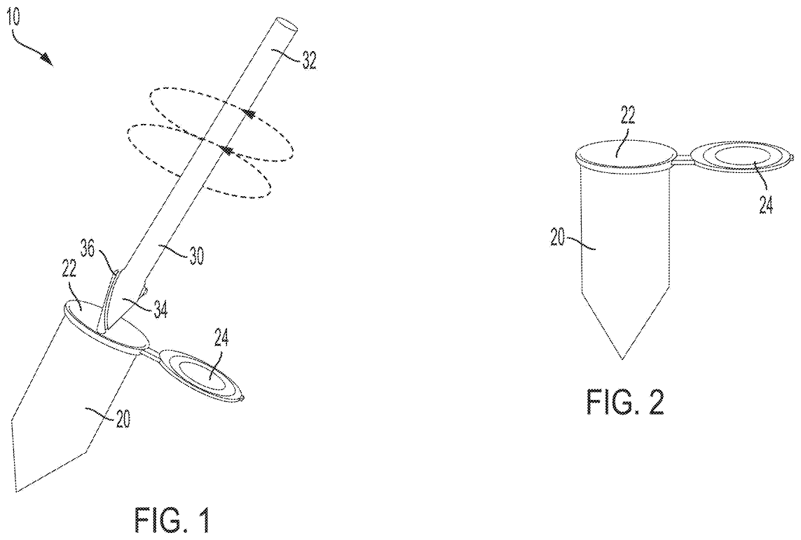

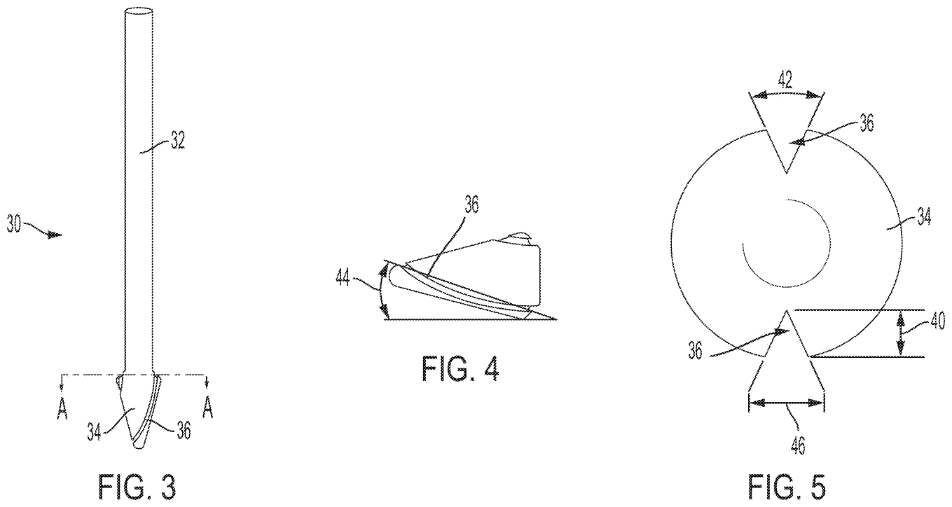

Referring to FIGS. 1-5, one embodiment or aspect of a tissue grinder 10 is shown. The tissue grinder 10 includes a collection microtube 20 and a pestle 30. As shown in FIGS. 1 and 2, the collection tube 20 includes a cavity 22 to receive a tissue sample therein and may or may not include a cap 24 to close the tissue sample within the cavity 22. As shown in FIGS. 1 and 3, the pestle 30 includes a rod 32 and a head 34 located at an end of the rod 32. The head 34 is shaped and sized to fit within the cavity 22 of the collection tube 20 in order to grind the tissue sample as will be described below. As shown, the head 34 has a generally conical shape and complements the shape of the collection tube 20. It is contemplated that the head 34 and collection tube 20 can take a variety of shapes so long as those shapes allow the head 34 to move within the cavity 22 of the collection tube 20 in order to grind the tissue. In other examples, the head 34 may be cylindrical and correspond to a cylindrical cavity 22. The head 34 may take a frustoconical shape, corresponding to a similarly shaped cavity. The head 34 and cavity 22 may even take complementary quadrilateral shapes. The shapes between the head 34 and cavity 22 may also be different, such as a conical head 34 corresponding to an entirely cylindrical cavity 22. In each of these instances, one will understand that the tissue grinder 10 can function so long as proper clearances are maintained between the head 34 and the cavity 22 to allow the head 34 to operate within the cavity 22 as is discussed below.

It is contemplated that the pestle 30 has a length ranging from 60-70 mm, the head 34 has a length ranging from 11-13 mm and a diameter ranging from 6-7 mm. It is further contemplated that these values may change and be adjusted based on the application of the tissue grinder 10. For example, if a particularly coarse substance is to be grinded, then the head 34 may have a larger length and/or diameter.

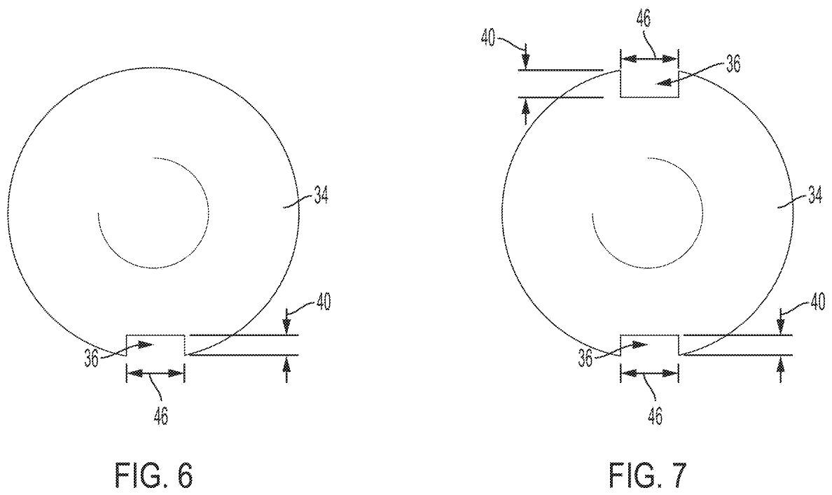

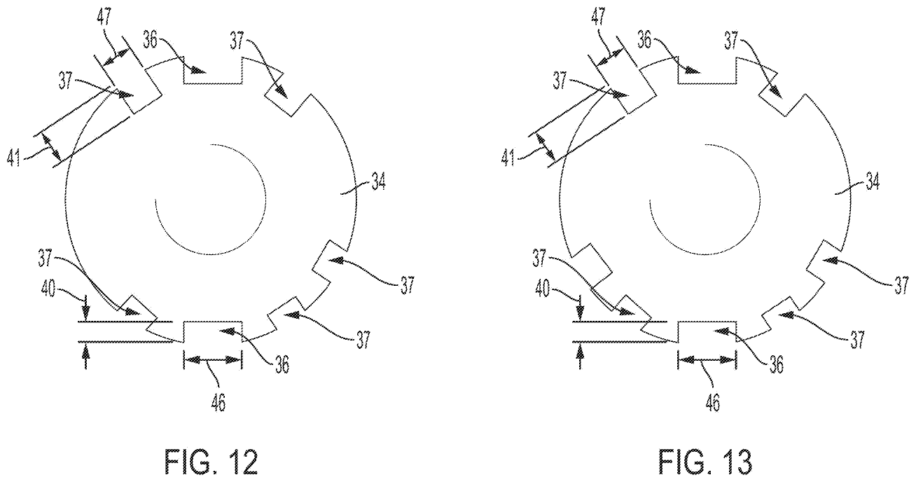

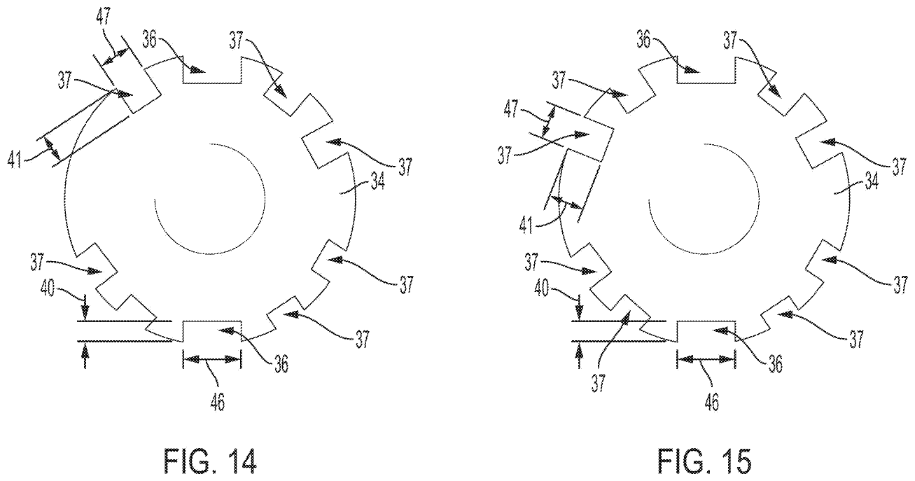

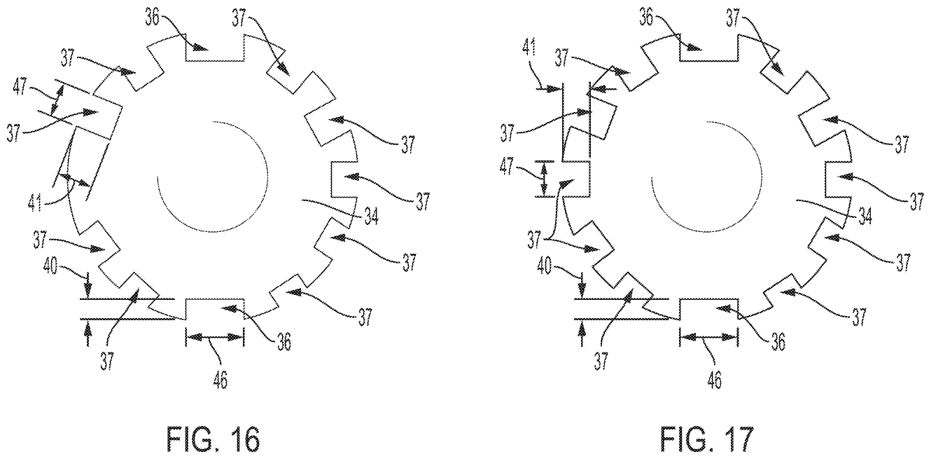

As shown in FIGS. 1 and 3-17, the head 34 of the pestle includes one or more grooves 36 extending about the outer surface. Each groove 36 extends a depth 40 into the head 34 and, as is shown in FIG. 5, forms an angle 42 relative to the long axis of the head 34 and rod 32. The depth 40 of the groove 36 can vary depending on the application. It is contemplated that the depth 40 of the grooves 36 can be 0.9-1.1 mm, but that may change if certain materials are to be ground. This angle 42 allows the groove to create a generally triangular shape relative to the head 34, forming a point at which the materials and tissue can be ground. When having a groove 36 with an angle 42, the angle 42 can be aligned with the long axis of the head 34, as shown, or the angle 42 can be skewed or tilted relative to the long axis. The angle 42 can extend from 0-60 degrees across the surface of the head 34. As shown in FIGS. 6-17, the grooves 36 are substantially quadrilateral in shape and extend across the head 34 a length 46. These will be discussed in greater detail below.

As shown in FIGS. 1, 3, and 4, the grooves 36 also extend at an angle 44 about the head 34. The angle 44 about which the grooves 36 extend can be determined by the number of grooves 36 provided on the head 34. As shown in FIG. 4, the end point of the groove 36, located at the tip of head 34, is approximately 20 degrees away from the starting point of the groove 36, relative to the curve of the head 34. The angles 44 about which the grooves 36 traverse typically range anywhere from 0-25 degrees; however, in instances where the head 34 is larger than the one shown, the grooves 36 can extend greater than 20 degrees. It is also contemplated the grooves 36 can make one or more rotations about the head 34 depending on how many grooves 36 are utilized and the length of the head 34. The angles and depths of the grooves 36 help to facilitate the grinding, cutting, and general breakdown of the tissue within the cavity 22.

As shown in FIGS. 6-17, the grooves 36 are cut more sharply in the direction of the axis of the head 34 in order to form a more square or quadrilateral shape when looking at the cross-sectional view. In this instance, the grooves 36 do not form an angle 44 relative to the long axis. Instead, the grooves 36 merely have a width 46 extending across the head 34 with the depth 40 extending into the head 34. The width 46, like the depth 40, may also be 0.9-1.1 mm.

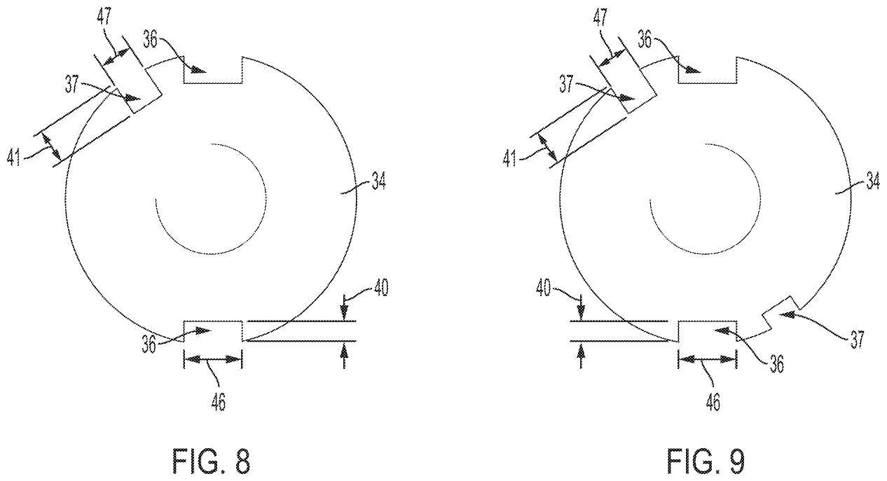

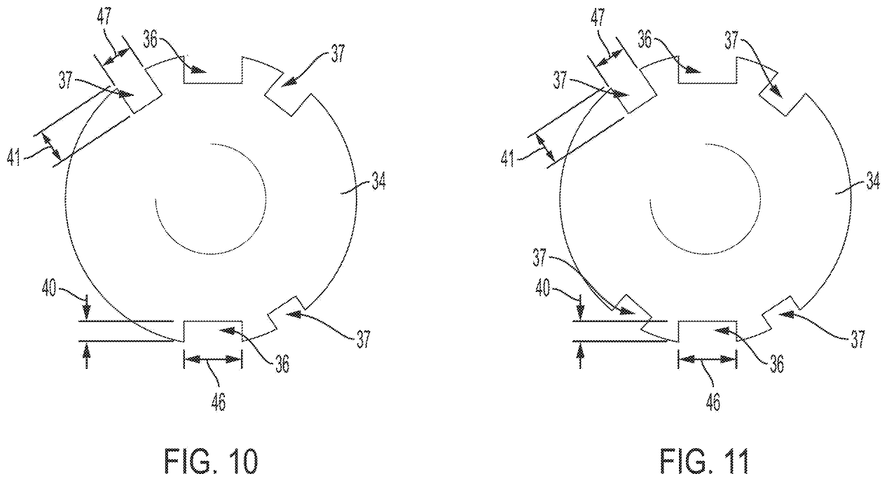

While only two grooves 36 having identical depths are shown in FIG. 5, any number of grooves 36 having a variety of depths and extending about the head 34 at a variety of angles can be used. FIGS. 6-17 show a variety of grooves 36, 37 extending into the head 34. FIGS. 6 and 7 respectively show one and two main grooves 36, both having the depth 40 and the width 46. In FIG. 7, the grooves 36 are 180 degrees apart from each other with respect to the circumference of the head 34. Beginning with FIG. 8, minor grooves 37 are introduced to the side(s) of one of the major grooves 36. The minor grooves 37 are smaller than the major grooves 36 and extend a depth 41 into the head 34 and a width 47 across the head. FIG. 9 shows two main grooves 36 and two minor grooves 37 both being located directly across from the other about the circumference of the head 34. These locations allow for each of the grooves 36, 37 to rotate or curl about the head 34 to the degree shown in FIG. 4. However, the grooves 36, 37 may be located about the head 34 at different locations, which may mean that the each groove 36, 37 curls about the head 34 an amount less than what is shown in FIG. 4. FIGS. 10-17 show different amounts of minor grooves 37 located about the head 34. As the number of grooves increases, the angle of curl shown in FIG. 4 decreases as the grooves 36, 37 will eventually interfere with each other about the head 34. However, some grooves 36, 37 may not extend along the entire length of the head 34, meaning that some grooves 36, 37 may curl about the head 34 at the angle shown in FIG. 4. It is also contemplated that some of the grooves 36, 37 may intersect and/or combine as they rotate about the head 34. It is further contemplated that the grooves 36, 37 extend into the head at different depths 40 and extend across the head 34 at different widths 46, 47. The depths 40 and widths 46, 47 of the grooves need not be uniform and may vary depending on the size of the head 34 and cavity 22 as well as the application. Typically, tissue grinders 10 work on tissue samples that have volumes the size of milliliters, so the cavity 22 and head 34 may have comparable volumes with the volume of the head 34 being in the milliliter range and the depths of the grooves 36 being in the millimeter range. However, depending on the amount of tissue to be sampled, larger sized collection tubes 20 and heads 34 may be used. The type of tissue being used in conjunction with the grinder 10 may also require a certain groove 36 number, angle, and depth.

With reference to FIG. 1, the operation of the tissue grinder 10 will now be described. First, a tissue sample is placed into the cavity 22 of the collection tube 20. Then the pestle 30 is placed head 34 first into the cavity 22, so the head 34 contacts at least a portion of the tissue sample. The rod 32 is then rotated and twisted in the direction of the arrows shown. The rod 32 can also be moved up and down. This movement brings the head 34 into repeated contact with the tissue sample and the walls of the cavity 22. The rotational movement of the rod 32 twists the head 34 about the tissue sample causing the tissue sample to rise up along the grooves 36, coming into contact with the edges formed by the grooves 36 as well as coming into contact with the inner wall of the cavity 22. This repeated contact between the head 34 and the tissue sample shears the tissue sample within the collection tube 20. The rotation of the rod 32 and the angular nature of the grooves 36 about the head 34 also ensure that clumps of the tissue sample do not pack together at the bottom of the collection tube 20. The nature of the tissue grinder 10 ensures that the tissue is broken down homogenously. The homogenous breakdown puts the tissue in a proper state so various scientific tests can be conducted on the sample. While a user may rotate the rod 32, it is also contemplated that the rod 32 can be attached to a device in order to rotate the pestle 30. After operation of the tissue grinder 10, testing can be done to the sample in the field or the cap 24 can be placed over the collection tube 20 to prevent contamination to the tissue sample in order for testing to be done later.

Typically, only wet or soft tissue can be sufficiently ground in systems known in the art. However, the grooves 36 are particularly sized and shaped to grind dry tissue such as those found in plants and other organisms. In order to be used on plant tissue, the grinder 10 can be made from material such as stiff plastic. Other disposable materials are contemplated to support a one-use type of tissue grinder 10 out in the field.

### EXAMPLES

A tissue grinder 10 with A) grooves 36 at 30 degrees from the long axis, B) groove 36 depth of 1 millimeter, and C) 2 grooves 36 in total.

A tissue grinder 10 with A) grooves 36 at 60 degrees from the long axis, B) depth of 2 millimeters, and C) 12 grooves 36 in total.

Although a tissue grinder has been described in detail for the purpose of illustration based on what is currently considered to be the most practical examples, it is to be understood that such detail is solely for that purpose and that the subject matter provided herein is not limited to the disclosed examples, but, on the contrary, is intended to cover modifications and equivalent arrangements. For example, it is to be understood that this disclosure contemplates that, to the extent possible, one or more features of any example can be combined with one or more features of any other example.

What is claimed is:

1. A tissue grinding device comprising:
a pestle comprising a rod and a head extending from an end of the rod, the head having a shape corresponding to a shape of an internal cavity of a hollow collection tube; and
at least one groove extending about an outer surface of the head of the pestle at an angle, the at least one groove extending a depth into the head of the pestle,
wherein the head of the pestle is configured to grind a substance within the internal cavity of the hollow collection tube.

2. The tissue grinding device of claim 1, wherein the at least one groove comprises 2-5 grooves.

3. The tissue grinding device of claim 1, wherein the at least one groove comprises at least 12 grooves.

4. The tissue grinding device of claim 1, wherein the at least one groove comprises at least one major groove and at least one minor groove.

5. The tissue grinding device of claim 4, wherein the at least one major groove comprises two major grooves, and the at least one minor groove comprises a plurality of minor grooves.

6. The tissue grinding device of claim 5, wherein the plurality of minor grooves comprises 10 minor grooves.

7. The tissue grinding device of claim 1, wherein the depth is 0.5-5 millimeters.

8. The tissue grinding device of claim 7, wherein the depth is 0.9-1.1 millimeters.

9. The tissue grinding device of claim 1, wherein the at least one groove comprises a width, and wherein the width is 0.5-2.0 millimeters.

10. The tissue grinding device of claim 9, wherein the width is 0.9-1.1 millimeters.

11. The tissue grinding device of claim 1, wherein the angle is 0-60 degrees.

12. The tissue grinding device of claim 11, wherein the angle is 15-25 degrees.

13. The tissue grinding device of claim 1, wherein the at least one groove is a triangle.

14. The tissue grinding device of claim 1, wherein the at least one groove is a quadrilateral.

15. A tissue grinding system comprising:
a hollow collection tube defining an internal cavity, the hollow collection tube comprising an opening and a lid corresponding to the opening; and
a tissue grinding device comprising:
a pestle comprising a rod and a head extending from an end of the rod, the head having a shape corresponding to the shape of the internal cavity; and
at least one groove extending about an outer surface of the head of the pestle at an angle, the at least one groove extending a depth into the head of the pestle,
wherein the head of the pestle is configured to grind a substance within the internal cavity.

16. The tissue grinding system of claim 15, wherein the hollow collection tube comprises a disposable material.

17. The tissue grinding system of claim 15, wherein the at least one groove comprises at least one major groove and at least one minor groove.

18. The tissue grinding system of claim 15, wherein the at least one groove is a triangle.

19. The tissue grinding system of claim 15, wherein the at least one groove is a quadrilateral having a width.

20. The tissue grinding system of claim 19, wherein the at least one groove is a square.
